(19) United States
(12) Patent Application Publication
(10) Pub. No.: US 2026/0363372 A1
(43) Pub. Date: Nov. 19, 2026

(54) GLOVE WITH A KNUCKLE PROTECTOR

(71) Applicant: Ivan Vos Holding B.V., Oss (NL)

(72) Inventors: Jasper den Dekker, Oss (NL); Dávid Zoltán Mozsgai, Oss (NL)

(21) Appl. No.: 19/674,271

(22) Filed: May 12, 2026

(30) Foreign Application Priority Data
May 15, 2025 (NL) 2040372

(51) Int. Cl. A41D 19/015; A41D 19/00; A41D 19/04; A41D 27/28; A63B 71/14; B33Y 80/00

(52) U.S. Cl. CPC A41D 19/01576; A41D 19/001; A41D 19/0024; A41D 19/0058; A41D 19/0065; A41D 19/0079; A41D 19/0096; A41D 19/01505; A41D 19/01523; A41D 19/01588; A41D 19/04; A41D 27/28; A63B 71/141; B33Y 80/00; A63B 71/143

(57) ABSTRACT

A motorcycle glove includes a knuckle protector embodied as a one-piece injection moulded part made of a thermoplastic elastomer such as TPU or a one-piece 3D printed part. The knuckle protector has a preformed 3D curved inner surface and a preformed 3D curved outer surface, wherein the curved inner surface shape is adapted to fit over the knuckles of a human hand, and wherein the protector has at least one portion comprising a cellular structure including cellular ventilation passages extending from the outer surface to the inner surface to allow air flow between the outer surface and the inner surface.

### CROSS-REFERENCE TO RELATED APPLICATIONS

This application claims the benefit of Netherlands Application No. 2040372, filed May 15, 2025, the contents of which is incorporated by reference herein.

### FIELD OF THE INVENTION

The present invention relates to a glove, in particular a motorcycle glove, comprising a knuckle protector made of a thermoplastic elastomer such as TPU.

### BACKGROUND OF THE INVENTION

DE 20 2007 012 154 U1 discloses a glove having a one-piece injection moulded knuckle protector made of a thermoplastic elastomer material. The knuckle protector is a separately formed component which can be stitched to the actual glove material through stitching perforations arranged at the peripheral zone of the knuckle protector. The knuckle protector does not have a ventilation feature.

KR 101098876 discloses a motorcycle glove which has a multi-part knuckle protector. This knuckle protector comprises a protective cap, an air inlet cap and a shock absorbing member. These parts are formed separately an assembled together: The air inlet cap extends over a surface of the protective cap to define an air inlet channel and the shock absorbing member is arranged underneath the protective cap. The shock absorbing member includes an air inlet hole which is in communication with the air inlet channel.

The present invention has for an object to provide a protective glove having a ventilated knuckle protector.

This object is achieved by a glove, in particular a motorcycle glove, according to the invention.

### SUMMARY OF THE INVENTION

A glove, in particular a motorcycle glove, comprising a knuckle protector embodied as a one-piece injection moulded part made of a thermoplastic elastomer (TPE) such as TPU, wherein the knuckle protector has a preformed 3D curved inner surface and a preformed 3D curved outer surface, wherein the curved inner surface shape is adapted to fit over the knuckles, in particular the metacarpophalangeal (MCP) joints, of a human hand, and wherein the protector has at least one ventilation portion comprising a cellular structure including cellular ventilation passages extending from the outer surface to the inner surface to allow air flow between the outer surface and the inner surface.

The cellular structure of the ventilation portion provides ventilation towards the inner side of the glove, while it provides sufficient strength and flexibility to protect the hand from damage during an impact, e.g. during a crash. In particular the knuckle protector is able to withstand the EN13594 impact test - level 1, without the knuckle protector being too thick or the TPE material, of which it is made, being too hard. Thus, the knuckle protector can be used without other absorbing layers, such as foam, having to be applied to the inner side, while impact protection and comfort of the hand is still warranted. The omission of absorbing materials saves material, reduces bulk and simplifies the manufacturing of the glove. Moreover, the cellular structure provides a more lightweight, flexible and material saving arrangement with regard to the known gloves.

In a possible embodiment the knuckle protector has a varying thickness between the inwardly facing surface and the outwardly facing surface, wherein the maximum thickness is 8 mm.

In possible embodiments the knuckle protector may have a Shore Hardness of from 50A to 70A. Within this Shore hardness range can be chosen between additional flexibility and optimised impact performance by selecting a hardness in a lower subrange and a higher subrange, respectively.

In a possible embodiment the knuckle protector has at most a Shore Hardness 66A. Such an embodiment is able to withstand EN13594 impact test - level 2, whilst still having a limited thickness of at most 8 mm.

In some embodiments the cellular structure may comprise a regular pattern of cellular ventilation passages. With “regular” is meant a repetitive arrangement of the same passage shapes. In other embodiments the cellular structure may comprise an irregular pattern of cellular ventilation passages. A glove having a cellular structure having a regular pattern and a further cellular structure having an irregular pattern is also conceivable.

In a possible embodiment the inner surface of the knuckle protector has an undulation which fits over the undulating shape of the knuckles of a human hand. Such an undulation provides wearing comfort to the user of the glove. Moreover, the 3D shape of the inner side of the knuckle protector and the undulation warrant that the knuckle protector does not have to be deformed when the user wears and uses the glove. It can retain more or less its original shape, whereby the risk that the ventilation channels are deformed, compressed and closed off is reduced.

In a further embodiment the knuckle protector comprises an undulating ridge at the outer surface, which undulating ridge follows the undulation of the inner surface. The undulation is thus similar on the inner and outer side. In this way the thickness of the knuckle protector may be within a certain safe range.

The undulation of the inner surface may at least partially be formed in the cellular structure.

In a possible embodiment the knuckle protector has a peripheral rim portion which is thin relative to the remainder of the knuckle protector. Preferably this peripheral rim portion is continuous along the periphery.

In an embodiment an inner lining of breathable material is arranged at least at the location of the cellular structure at the inwardly facing surface of the knuckle protector. The breathable material may for example be a mesh. The mesh is made of a fabric, e.g. of polyester. Such a mesh allows air to pass, but for example prevents insects or other small objects to enter the inside of the glove via the ventilation passages and reach the hand of the user. Furthermore, the mesh functions as a distance holder for the individual ventilation holes with respect to the hand, such that the ventilation holes are not pressed onto the hand. Thereby is prevented that the air passages are closed off by the hand which would hamper the airflow over the hand inside the glove.

The inner lining may in some embodiments be attached to the peripheral rim portion of the knuckle protector. Preferably the inner lining is stitched to the peripheral rim portion of the knuckle protector.

Instead of a separately made mesh, which is attached to the knuckle protector, it is in an alternative embodiment conceivable to form a mesh integrally on the inner side of the knuckle protector, which integrally formed mesh forms a sort of relief on said inner side. This mesh could be e.g. a grid of ribs protruding from said inner side. The openings defined by said integral mesh are smaller than the area of the air passages in the ventilation portions, such that entrance of insects is prevented and such that is prevented that the inner end of the air passages is pressed onto the hand, which would hamper ventilation airflow. This integral mesh can made of the same material as the knuckle protector.

In a practical embodiment the peripheral rim portion of the knuckle protector is attached to an outer shell material of the glove. The outer shell material may for example be leather or a similar material. Preferably the peripheral rim portion of the knuckle protector is stitched to the outer shell material. The peripheral rim portion and the inner lining (e.g. mesh) can be stitched to the outer shell material by one or more common stitches.

In embodiments the cellular passages each have a central axis extending rectilinear from the outer surface to the inner surface of the knuckle protector.

In some embodiments the cellular ventilation passages have a tapering shape from the outer side to the inner side. Advantageously the tapering shape makes the cellular passage function as an “airscoop”, i.e. the velocity of the air flow increases towards the inner side, which is advantageous for the ventilation purpose.

In some embodiments the cellular structure has a density of cellular ventilation passages which varies over the cellular structure.

In other embodiments the cellular structure has a density of cellular ventilation passages which is substantially constant over the cellular structure.

The invention also relates to a glove, in particular a motorcycle glove, comprising a knuckle protector, wherein the knuckle protector has a preformed 3D curved inner surface and a preformed 3D curved outer surface, wherein the curved inner surface shape includes an undulation to fit on the knuckles, in particular the metacarpophalangeal (MCP) joints, of a human hand, and wherein the protector has at least one ventilation portion comprising a framework of partition elements (walls) defining a cellular structure of air passages extending from the outer surface to the inner surface.

The knuckle protector could be an injection moulded part. If it is an injection moulded part the cellular structure provides a cellular pattern on the outer surface and the inner surface. This injection moulded part is advantageously made of a thermoplastic elastomer (TPE), e.g. a Thermoplastic Urethane (TPU).

In another embodiment the knuckle protector could also be a 3D printed part. In particular if the knuckle protector is made by a 3D printing process, the cellular structure can be a 3D cellular structure in which air cells in the material are in communication with each other and form a porous structure through which air can flow.

The 3D printing process may be resin printing, in particular LCD printing, which is s a type of resin-based 3D printing technology that uses Liquid Crystal Display (LCD) screens to cure photopolymer resin layer by layer with UV light. A material that can be used is Acrylated Aliphatic Urethane, in particular Polyurethane Acrylate (PUA).

Other possible 3D printing techniques to make the knuckle protector could be Stereolithography SLA, Digital Light Processing (DLP), Digital Light Synthesis (DLS), Selective Laser Sintering (SLS) and Material Jetting (MJ).

However, a 3D printed knuckle protector can also have a 2D cellular structure, i.e. there is cellular pattern at the outer surface and the inner surface, e.g. a Voronoi pattern, and the cells form a direct passage from the outer surface to the inner surface.

The 3D printed knuckle protectors can have complex 3D structures, which are optimised for ventilation characteristics, flexibility, weight and/or the dampening of forces, while they are at least able to withstand the EN13594 impact test - level 1 or 2.

In a specific embodiment of the glove, the framework of partition elements forms a lattice structure.

In specific embodiments of the gloves as described in the above an overlay may be arranged over the outer surface of the knuckle protector, which overlay has a higher abrasion resistance than the knuckle protector. Such an embodiment of the glove is specifically suitable for motorcycle racing. The overlay is a sort of hardshell, which makes the knuckle protector slide over the road surface upon impact rather than getting grip on the road surface. Furthermore, the overlay has a force distributing effect, which may allow a thickness reduction of the TPE material of the knuckle protector. The overlay may be provided with at least one ventilation aperture, which is in communication with at least one cellular passage of the knuckle protector. For example, a ventilation aperture in the overlay may overlap with the inlet side (at the outer side) of one or more cellular passages.

The invention also relates to a knuckle protector for incorporation in a glove as described in the above.

The invention also relates to a method for manufacturing a knuckle protector for a glove, wherein the knuckle protector is injection moulded of a thermoplastic elastomer such as TPU, wherein the knuckle protector has a preformed 3D curved inner surface and a preformed 3D curved outer surface, wherein the curved inner surface shape is adapted to fit over the knuckles of a human hand, and wherein the protector has at least one ventilation portion comprising a cellular structure including cellular ventilation passages extending from the outer surface to the inner surface to allow air flow between the outer surface and the inner surface.

The invention also relates to a method for manufacturing a knuckle protector for a glove, wherein the knuckle protector is made by 3D printing of filaments, powders or resins, wherein the knuckle protector has a preformed 3D curved inner surface and a preformed 3D curved outer surface, wherein the curved inner surface shape includes an undulation to fit on the knuckles of a human hand, and wherein the protector has at least one ventilation portion comprising a framework of partition elements defining a cellular structure of air passages extending from the outer surface to the inner surface. Preferably the cellular structure is made by 3D-printing a lattice structure.

The 3D printing process used in the method is preferably resin printing, in particular LCD printing, which is s a type of resin-based 3D printing technology that uses Liquid Crystal Display (LCD) screens to cure photopolymer resin layer by layer with UV light. A suitable material to be used is Acrylated Aliphatic Urethane, in particular Polyurethane Acrylate (PUA).

Other possible 3D printing techniques to make the knuckle protector could be Stereolithography – (SLA), Digital Light Processing (DLP), Digital Light Synthesis (DLS), Selective Laser Sintering (SLS) and Material Jetting (MJ), which are known to a person skilled in the art. SLA, DLP, DLS and MJ are resin-based, SLS is a powder-based 3D printing process.

In a further step in the manufacturing method the knuckle protector is attached to the outer shell of a glove. Preferably the knuckle protector is stitched in the outer shell of the glove. The outer shell is possibly provided with a cutout window in which the knuckle protector is arranged, and a dedicated peripheral rim of the knuckle protector overlaps with the outer shell material adjacent the cutout window. The overlapping peripheral rim and outer shell material are attached to each other. Preferably they are stitched to each other.

If there is an inner lining, the inner lining (e.g. a mesh) can be stitched with the knuckle protector to the outer shell material (e.g. of leather) by one or more common stitches.

The invention will be further elucidated in the following description with reference to the drawings.

### BRIEF DESCRIPTION OF THE DRAWINGS

FIG. 1 shows a view in perspective of an embodiment of a motorcycle glove according to the invention,

FIG. 2 shows an exploded view of a part of the glove of FIG. 1,

FIG. 3 shows a view in perspective of a knuckle protector incorporated in the glove of FIG. 1,

FIG. 4 shows a top elevational view of the knuckle protector of FIG. 3,

FIG. 5 shows the knuckle protector in a cross-section A-A indicated in FIG. 4,

FIG. 6 shows the knuckle protector in a cross-section B-B indicated in FIG. 4,

FIG. 7 shows a view in perspective of another embodiment of a knuckle protector according to the invention,

FIG. 8 shows a top elevational view of the knuckle protector of FIG. 7,

FIG. 9 shows a view in perspective of another embodiment of a knuckle protector according to the invention,

FIG. 10 shows a top elevational view of the knuckle protector of FIG. 9,

FIG. 11 shows a view in perspective of another embodiment of a knuckle protector according to the invention,

FIG. 12 shows a top elevational view of the knuckle protector of FIG. 11,

FIG. 13 shows a view in perspective of another embodiment of a knuckle protector according to the invention,

FIG. 14 shows a top elevational view of the knuckle protector of FIG. 13,

FIG. 15 shows a view in perspective of another embodiment of a knuckle protector according to the invention,

FIG. 16 shows a top elevational view of the knuckle protector of FIG. 15,

FIG. 17 shows a view in perspective of another embodiment of a knuckle protector according to the invention,

FIG. 18 shows a top elevational view of the knuckle protector of FIG. 17,

FIG. 19 shows a view in perspective of another embodiment of a knuckle protector according to the invention,

FIG. 20 shows a top elevational view of the knuckle protector of FIG. 19,

FIG. 21 shows the knuckle protector in a cross-section A-A indicated in FIG. 20,

FIG. 22 shows the knuckle protector in a cross-section B-B indicated in FIG. 20,

FIG. 23 shows a top elevational view of another embodiment of a knuckle protector according to the invention,

FIG. 24 shows the knuckle protector in a cross-section A-A indicated in FIG. 23,

FIG. 25 shows a view in perspective of a part of another embodiment of a motorcycle glove according to the invention,

FIG. 26 shows an exploded view of the part of the glove of FIG. 25, and

FIG. 27 shows a cross section through the knuckle protector of the glove of FIG. 25,

FIG. 28 shows an exploded view of yet another knuckle protector according to the invention,

FIG. 29 shows a top elevational view of the knuckle protector of FIG. 28,

FIG. 30 shows the knuckle protector in a cross-section A-A indicated in FIG. 29, and

FIG. 31 shows the knuckle protector in a cross-section B-B indicated in FIG. 29.

### DETAILED DESCRIPTION

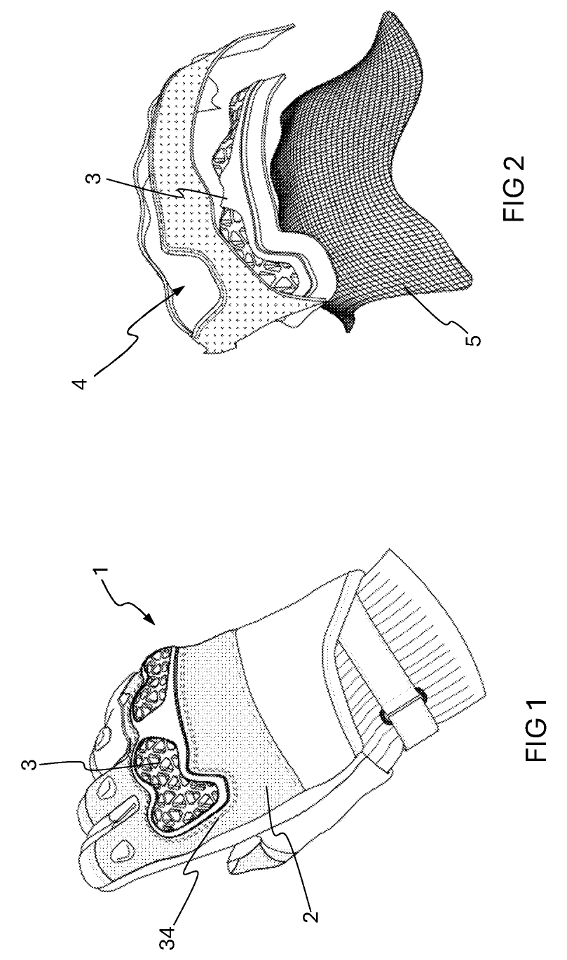

In FIG. 1 a motorcycle glove 1 according to the invention is shown. The glove 1 comprises an outer shell 2, which may for example be made of leather. In the glove 1 a knuckle protector 3 is incorporated. The knuckle protector 3 is received in a cut-out window 4 provided in the outer shell 2. The cut-out window 4 is best visible in FIG. 2.

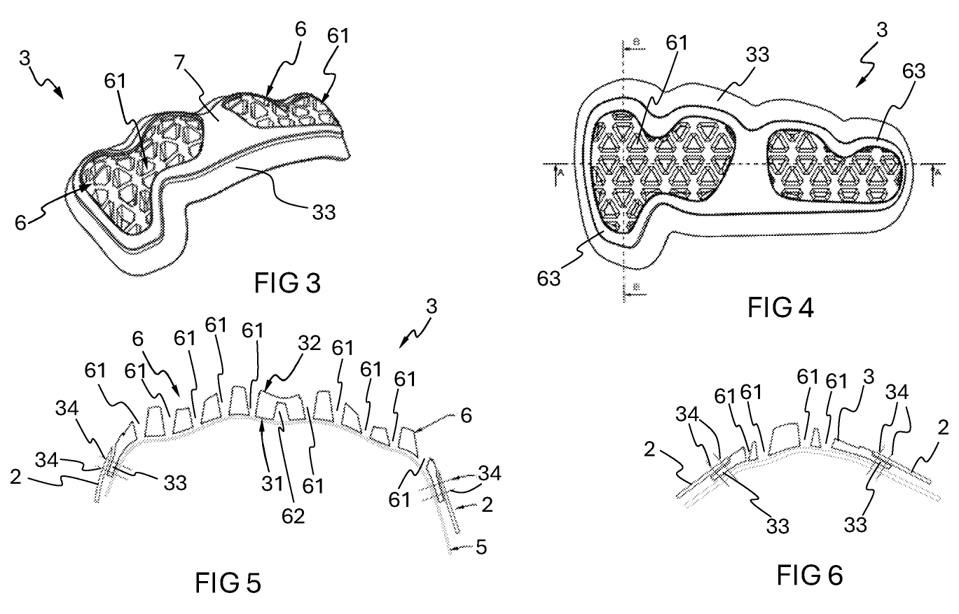

The knuckle protector 3 is shown separately in FIGS. 3 and 4. The knuckle protector 3 is a one-piece injection moulded part. It is made of a thermoplastic elastomer (TPE), such as for example a TPU. The knuckle protector 3 preferably has a Shore Hardness A of at most 66 to provide sufficient wearing comfort for the wearer of the glove 1.

As is visible in the cross-sectional views of FIGS. 5 and 6 the knuckle protector 3 has a preformed 3D curved inner surface 31 and a preformed 3D curved outer surface 32. The inner surface 31 and the outer surface 32 are preformed in the sense that they are form stable and have this shape as shown after they have been moulded and cured. There is no additional reshaping when the knuckle protector 3 is arranged in and fixed in the glove 1. This is contrary to other known knuckle protectors, which have at least a generally flat inner side, and which are bent when they are arranged and fixed in a glove.

The distance between the inner surface 31 and the outer surface 32 of the knuckle protector 3 determines a thickness profile of the knuckle protector 3. The knuckle protector 3 has a varying thickness between the inwardly facing surface 31 and the outwardly facing surface 32. The maximum thickness is 8 mm.

The knuckle protector 3 comprises a peripheral rim portion 33. This peripheral rim portion 33 has a considerably smaller thickness than the portion it surrounds. The peripheral rim portion 33 is designed to overlap with the shell material 2 of the glove 1 which is adjacent to the cut-out 4 in the shell material as is visible in the cross-sectional views of FIGS. 5 and 6. The shell material 2 of the glove 1 is attached to the peripheral rim portion 33. Preferably the peripheral rim portion 33 and the shell material 2 are attached to each other by stitches 34 as is visible in FIGS. 1, 5 and 6.

The curved inner surface 31 of the knuckle protector 3 is adapted to fit over the knuckles, i.e. the metacarpophalangeal (MCP) joints, of a human hand which is best visible in FIG. 5. On the inner side 31 of the knuckle protector 3 a mesh 5 is arranged. In the embodiment shown the mesh 5 is stitched by the same stitches 34 to the peripheral rim portion 33. It is however also possible to attach the mesh 5 in another way to the knuckle protector 1, e.g. by an adhesive or other bonding means. The mesh 5 prevents for example that insects or floating particles can access the glove and reach the skin of the user. Furthermore, the (3D) mesh also facilitates the airflow because it functions as a distance holder between skin of the hand in the glove 1 and solid portions (i.e. non holed) of the knuckle protector 3. Thereby sealing of the outlet of the ventilation passages 61, which will be described in the following, by the skin of the hand, is prevented.

The knuckle protector 1 of FIG. 3 has two ventilation portions 6, each comprising a cellular structure including cellular ventilation passages 61 extending from the outer surface 32 to the inner surface 31 to allow air flow between the outer surface 32 and the inner surface 31.

In this example the ventilation passages 61 have a substantially triangular shape. In a plane view from above (cf. FIG. 4) it is visible that the cellular structure comprises a regular pattern of cellular ventilation passages 61. The ventilation passages 61 have the same triangular shape and size at the outer surface 32 as far as they entirely fit in the area. At the edges of the ventilation portions 6 or ventilation zones, the ventilation passages 61 are smaller because they are cut off by the circumferential edge 63 of the zone 6. The cellular structure in this example has a density of cellular passages 61 which is substantially constant over the cellular structure.

The ventilation portions 6 in this embodiment are separated by a portion 7 without ventilation passages. As can be seen in FIG. 5 the portion 7 may be provided with one or more blind holes 62, i.e. holes which fit in the cellular pattern on the inner surface 31, but which are closed at the outer surface 32. These blind holes 62 provide additional flexibility.

The knuckle protector 1 having the cellular structures in the ventilation portions 6 is able to withstand the EN13594 impact test - level 2, without the knuckle protector 1 being locally thicker than 8 mm or the TPE material, of which it is made, being too hard, i.e. harder than Shore Hardness A of 66. This leads to a glove which is comfortable to wear and is safe and which is relatively lightweight.

In the knuckle protector according to the invention, it is envisaged that the ventilation portions may be embodied in different ways. In particular the cellular structures may vary in shape of the ventilation passages and their distribution over the ventilation portion 6. The pattern may be regular or irregular and have a constant density or a varying density.

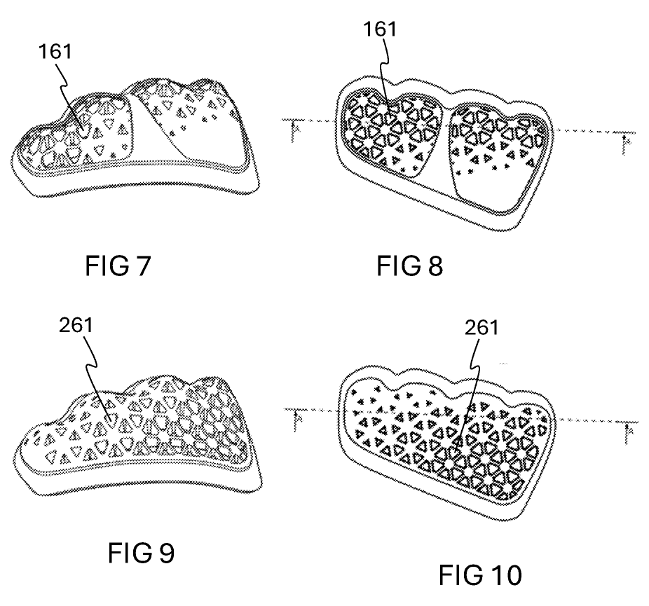

In FIGS. 7 and 8 an example of a knuckle protector is shown, having a cellular structure in which ventilation passages 161 also have a triangular shape, but wherein the cellular structure has a varying density over the cellular structure.

In FIGS. 9 and 10 yet another embodiment of a knuckle protector is shown, having a cellular structure in which ventilation passages 261 also have a triangular shape and wherein the cellular structure has a varying density over the cellular structure, albeit in another distribution as in FIGS. 7 and 8.

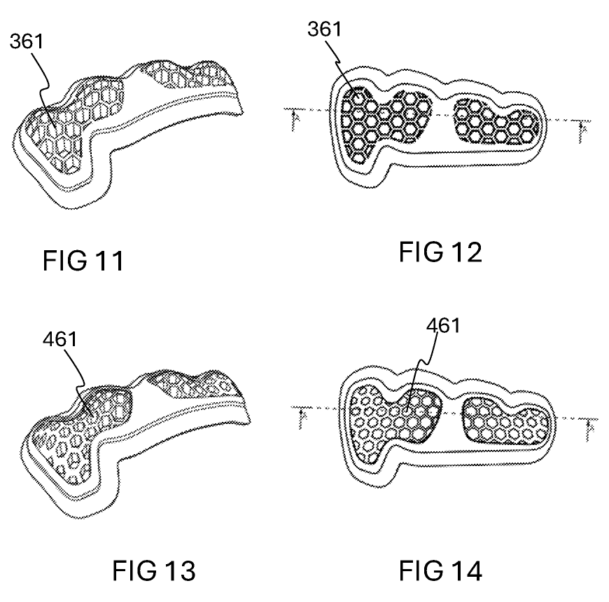

In FIGS. 11 and 12 yet another example of a knuckle protector is shown, having a cellular structure having a honeycomb pattern, in which ventilation passages 361 have a hexagonal shape. The pattern is regular and the density is constant.

In FIGS. 13 and 14 another example of a knuckle protector is shown, having a cellular structure in which ventilation passages 461 also have a hexagonal shape, but wherein the pattern has a varying density.

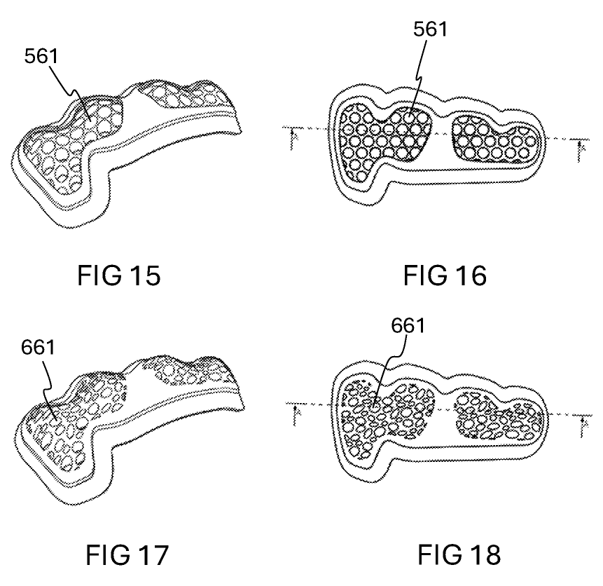

In FIGS. 15 and 16 is shown another example of a knuckle protector. In this example the cellular structures have ventilation passages 561 with a circular shape. The pattern is regular and the density is constant.

In FIGS. 17 and 18 is shown yet another example of a knuckle protector. In this example the cellular structures have ventilation passages 661 with a round shape having varying sizes and shapes. The pattern is thus irregular. The density varies.

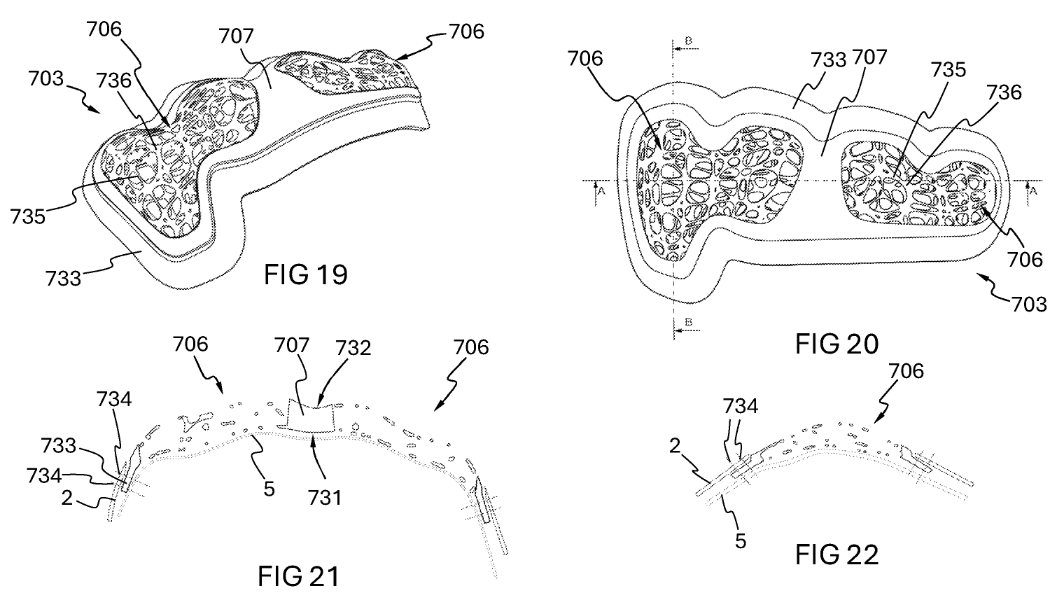

The embodiments of the knuckle protector in the FIGS. 1-18 are preferably made by an injection moulding process, e.g. from TPU, but can also be made by a 3D printing process. In FIGS. 19-24 however, examples of a knuckle protector are shown, which have a cellular structure that can be made by 3D printing, but cannot be made by injection moulding.

The 3D printed knuckle protectors 703 or 803 shown in FIGS. 19-24 are preferably made by a resin printing process. In particular LCD printing can be used, which is a type of resin-based 3D printing technology that uses Liquid Crystal Display (LCD) screens to cure photopolymer resin layer by layer with UV light. A suitable material to be used is Acrylated Aliphatic Urethane, in particular Polyurethane Acrylate (PUA).

Other possible 3D printing techniques to make the knuckle protector 703, 803 could be Stereolithography – (SLA), Digital Light Processing (DLP), Digital Light Synthesis (DLS), Selective Laser Sintering (SLS) and Material Jetting (MJ).

The knuckle protector 703 in FIG. 19 has a preformed 3D curved inner surface 731 and a preformed 3D curved outer surface 732, as is visible in FIG. 19 and in the cross sectional views of FIGS. 21 and 22. The inner surface 731 and the outer surface 732 are preformed in the sense that they are form stable and have this shape as shown after they have been 3D-printed and cured. There is no additional reshaping when the knuckle protector 703 is arranged in and fixed in the glove 1 (cf. FIG. 1).

The distance between the inner surface 731 and the outer surface 732 of the knuckle protector 703 determines a thickness profile of the knuckle protector 703. The knuckle protector 703 has a varying thickness between the inwardly facing surface 731 and the outwardly facing surface 732.

The knuckle protector 703 comprises a peripheral rim portion 733. This peripheral rim portion 733 has a considerably smaller thickness than the portion it surrounds. The peripheral rim portion 733 is designed to overlap with the shell material 2 (e.g. leather) of the glove 1 which is adjacent to the cut-out window 4 (cf. FIG. 2) in the shell material 2 as is visible in the cross-sectional views of FIGS. 21 and 22. The shell material 2 of the glove 1 is attached to the peripheral rim portion 733. Preferably the peripheral rim portion 733 and the shell material 2 are attached to each other by a stitching 734 as is visible in FIGS. 21 and 22. This is so called “window stitching” (cf. FIG. 2).

The curved inner surface 731 of the knuckle protector 703 is adapted to fit over the knuckles, i.e. the MCP joints, of a human hand which is best visible in FIG. 21. On the inner side 731 of the knuckle protector 703 a mesh 5 is arranged. In the embodiment shown in FIGS. 21 and 22 the mesh 5 is stitched by the same stitching seams 734 to the peripheral rim portion 733. It is however also possible to attach the mesh 5 in another way to the knuckle protector 703, e.g. by an adhesive or other bonding means. The mesh 5 prevents for example that insects or floating particles can access the glove and reach the skin of the user. Furthermore, the (3D) mesh also facilitates the airflow because it functions as a distance holder between skin of the hand in the glove and solid parts (i.e. non holed) of the knuckle protector 703. Thereby sealing of the outlet of the ventilation passages by the skin of the hand is prevented.

The knuckle protector 701 of FIG. 19 has two ventilation portions 706, each comprising a lattice structure defining a cellular pattern of air passages extending from the outer surface to the inner surface to allow air flow between the outer surface 732 and the inner surface 731. The structure is a 3D structure which comprises lattices 735 and nodes 736, cf. FIGS. 19 and 20. The ventilation portions 706 in this embodiment are separated by an intermediate portion 707 without ventilation passages.

The cellular structure is a 3D cellular structure in which air cells in the material are in communication with each other and form a porous structure through which air can flow. In the embodiment shown in FIGS. 19-22 the porous structure is quite open, whereby air flows easily through. Alternatively, other, more dense porous structures can be made, causing the air flow to follow a longer path from the outer surface to the inner surface.

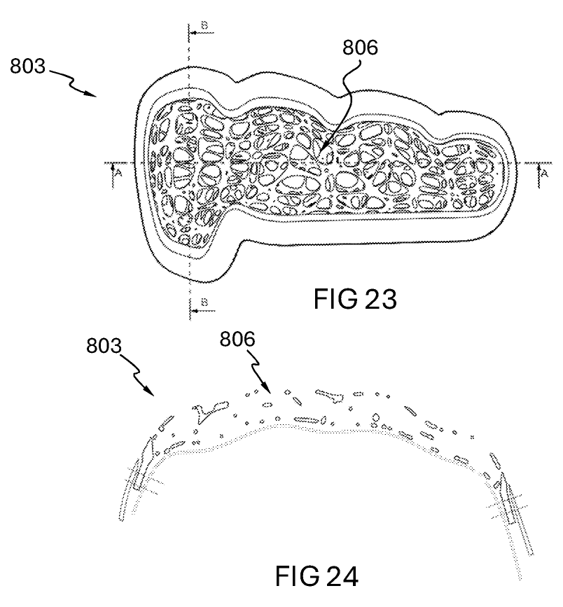

In FIGS. 23 and 24 a 3D printed knuckle protector 803 is shown with a comparable lattice structure defining a cellular pattern of air passages. The difference with the embodiment of FIG. 19 is that there is one big ventilation portion 806 instead of two ventilation portions.

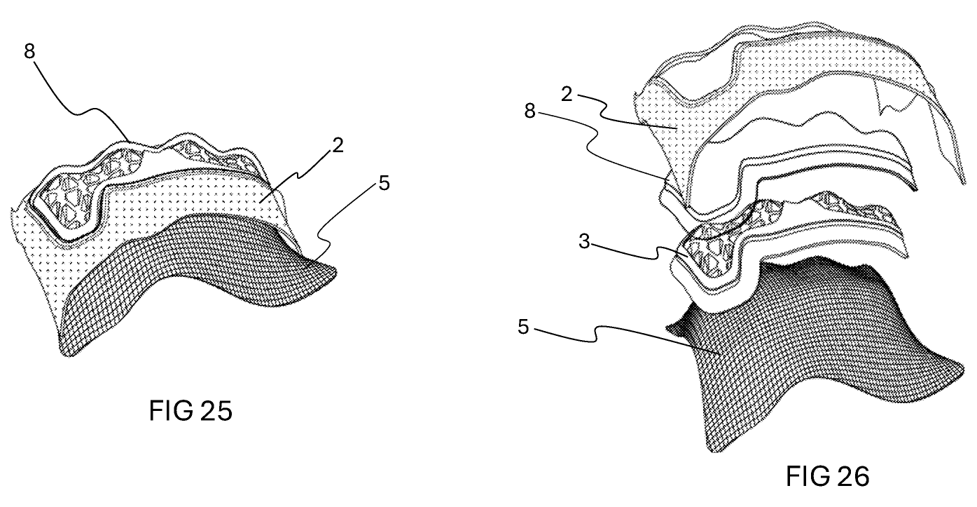

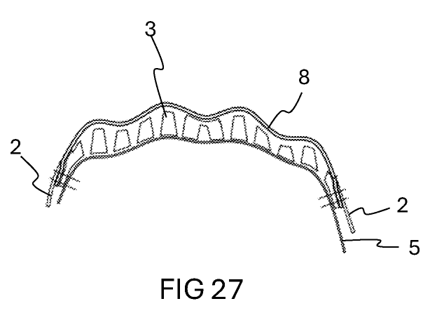

In FIGS. 25-27 is shown a first embodiment of a glove, wherein an overlay 8 is arranged over the outer surface of the knuckle protector. The knuckle protector 3, the shell material 2 and the mesh 5 can be the same as in the embodiment of FIGS. 1-6. However, over the outer side of the knuckle protector 3 an additional overlay 8 is arranged, which has a higher abrasion resistance than the thermoplastic elastomer of the knuckle protector 3. The overlay 8 can for example be made of TPU, e.g. injection moulded with a Shore Hardness of 70D. In other embodiments the overlay 8 may be made of PVC or PC (Polycarbonate) by thermoforming or pressforming.

By way of example, the overlay 8 shown in FIGS. 25-27 has no apertures and would cover the entire surface at the cellular structures, whereby no ventilation would be allowed. Although not preferred at this moment such an embodiment would still benefit from the cellular structure which provides an advantageous weight reduction and flexibility which facilitates comfort and possible impact absorption.

The overlay 8 may be made of a transparent material, e.g. Polycarbonate (PC). The example of the overlay 8 without apertures simply better illustrates the transparency. In the example made of Polycarbonate, the overlay 8 may be transparent, whereby the cellular structure of the knuckle protector is visible.

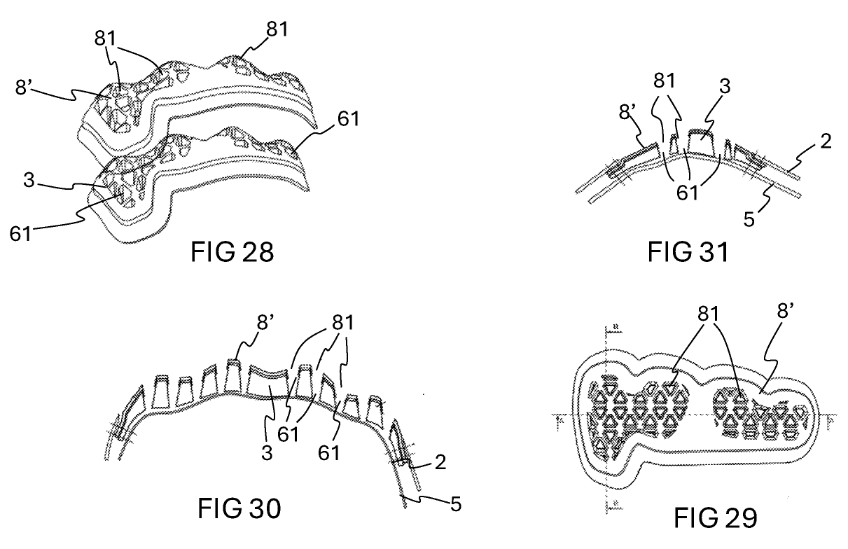

In FIG. 28-31 another embodiment of a knuckle protector with an overlay 8’ is shown. In this embodiment the overlay 8’ has ventilation apertures 81 which are aligned with the cellular passages 61 in the TPE body of the knuckle protector (in the figure only a few ventilation apertures 81 and air passages 61 are indicated by a reference numeral, but it will be clear to the skilled person). In the embodiment shown in FIGS. 28-31 each ventilation aperture 81 is associated with one ventilation passage 61 (they have the same pattern on the outer side). However, in alternative embodiments, it is possible that a ventilation aperture overlaps with a plurality of ventilation passages 61, and even that some passages 61 are covered (closed) and other passages 61 are not covered by the overlay (the passages are thus open).

The overlay 8’ can for example be made of TPU, e.g. injection moulded with a Shore Hardness of 70D. In other embodiments the overlay 8’ may be made of PVC or PC (Polycarbonate) by thermoforming or pressforming. The overlay 8’ may be transparent.

An embodiment of the glove, wherein the TPE body 3 is provided with an overlay 8, 8’ on the outer side, is specifically suitable for motorcycle racing. The overlay 8, 8’ is a sort of hardshell, which makes the knuckle protector slide over the road surface upon impact rather than getting grip on the road surface. Furthermore, the overlay 8, 8’ has a force distributing effect, which may allow a thickness reduction of the TPE material of the knuckle protector.

We claim:

1. A glove, in particular a motorcycle glove, comprising a knuckle protector embodied as a one-piece injection moulded part made of a thermoplastic elastomer such as TPU, wherein the knuckle protector has a preformed 3D curved inner surface and a preformed 3D curved outer surface, wherein the curved inner surface has a shape adapted to fit over knuckles of a human hand, and wherein the protector has at least one ventilation portion comprising a cellular structure including cellular ventilation passages extending from said outer surface to said inner surface to allow air flow between said outer surface and said inner surface.

2. The glove according to claim 1, wherein the cellular structure comprises a regular pattern of cellular ventilation passages and/or an irregular pattern of cellular ventilation passages.

3. The glove according to claim 1, wherein the knuckle protector has a varying thickness between said inner surface and said outer surface, with a maximum thickness of 8 mm.

4. The glove according to claim 1, wherein the knuckle protector has a Shore Hardness of from 50A to 70A.

5. The glove according to claim 1, wherein said inner surface of the knuckle protector has an undulation which fits over the undulating shape of the knuckles of a human hand.

6. The glove according to claim 5, wherein the knuckle protector comprises an undulating ridge at said outer surface, which undulating ridge follows the undulation of the inner surface.

7. The glove according to claim 5, wherein the undulation of the inner surface is at least partially formed in the cellular structure.

8. The glove according to claim 1, wherein the knuckle protector has a peripheral rim portion which is thin relative to the remainder of the knuckle protector, said peripheral rim portion of the knuckle protector being attached to an outer shell material of the glove.

9. The glove according to claim 1, wherein an inner lining of breathable material is arranged at least at the location of the cellular structure at said inner surface of the knuckle protector.

10. The glove according to claim 1, wherein the cellular passages each have a central axis extending rectilinear from said outer surface to said inner surface of the knuckle protector.

11. The glove according to claim 1, wherein the cellular structure has a density of cellular passages, which density varies over said cellular structure or is constant over said cellular structure.

12. A glove, in particular a motorcycle glove, comprising a knuckle protector, the knuckle protector having a preformed 3D curved inner surface and a preformed 3D curved outer surface, wherein the 3D curved inner surface has a shape including an undulation to fit on knuckles of a human hand, and wherein the protector has at least one ventilation portion comprising a framework of partition elements defining a cellular pattern of air passages extending from said outer surface to said inner surface.

13. The glove according to claim 12, wherein the framework of partition elements form a lattice structure.

14. The glove according to claim 12, wherein the knuckle protector is an injection moulded part.

15. The glove according to claim 12, wherein the knuckle protector is a 3D printed part.

16. The glove according to claim 15, wherein the cellular structure is a 3D cellular structure in which air cells in the printed part are in communication with each other and form a porous structure through which air can flow.

17. The glove according to claim 15, wherein the cellular structure is a 2D cellular structure, i.e. there is cellular pattern at said outer surface and said inner surface of the knuckle protector, and the cells of said cellular structure form a direct passage from said outer surface to said inner surface.

18. The glove according to claim 12, wherein the 3D printed knuckle protector is at least able to withstand the EN13594 impact test - level 1.

19. The glove according to claim 1, wherein an overlay is arranged over said outer surface of the knuckle protector, which overlay has a higher abrasion resistance than the knuckle protector.

20. A method for manufacturing a knuckle protector for a glove, wherein the knuckle protector is injection moulded of a thermoplastic elastomer such as TPU, wherein the knuckle protector has a preformed 3D curved inner surface and a preformed 3D curved outer surface, wherein said curved inner surface shape is adapted to fit over knuckles of a human hand, and wherein the protector has at least one ventilation portion comprising a cellular structure including cellular ventilation passages extending from said outer surface to said inner surface to allow air flow between said outer surface and said inner surface, or wherein the knuckle protector is made by 3D printing of filaments, powders or resins, wherein the knuckle protector has a preformed 3D curved inner surface and a preformed 3D curved outer surface, wherein said curved inner surface shape includes an undulation to fit on knuckles of a human hand, and wherein the protector has at least one ventilation portion comprising a framework of partition elements defining a cellular structure of air passages extending from said outer surface to said inner surface.
